(19) United States
(12) Patent Application Publication
(10) Pub. No.: US 2026/0045481 A1
(43) Pub. Date: Feb. 12, 2026

(54) ELECTRODE BODY FOR SECONDARY BATTERY

(71) Applicant: TOYOTA JIDOSHA KABUSHIKI KAISHA, Toyota-shi (JP)

(72) Inventors: Hirokazu TAKEUCHI, Toyota-shi (JP); Shinji KOJIMA, Nagoya-shi (JP); Takahiko NAKANO, Nagoya-shi (JP); Yusuke KINTSU, Miyoshi-shi (JP)

(73) Assignee: TOYOTA JIDOSHA KABUSHIKI KAISHA, Toyota-shi (JP)

(21) Appl. No.: 19/069,703

(22) Filed: Mar. 4, 2025

(30) Foreign Application Priority Data
Aug. 8, 2024 (JP) 2024-133310

(51) Int. Cl. H01M 4/13; H01M 4/04; H01M 4/139; H01M 4/36; H01M 4/62

(52) U.S. Cl. CPC H01M 4/13; H01M 4/0404; H01M 4/139; H01M 4/366; H01M 4/622

(57) ABSTRACT

An electrode body having a current collector layer and an active material layer laminated on the current collector layer, wherein the active material layer has a first layer on the current collector layer and a second layer on the first layer, the first binder included in the first layer is composed of particles in a surface contact shape, and the second binder included in the second layer is composed of particles in a point contact shape.

### CROSS-REFERENCE TO RELATED APPLICATION

This application claims priority to Japanese Patent Application No. 2024-133310 filed on Aug. 8, 2024. The disclosure of the above-identified application, including the specification, drawings, and claims, is incorporated by reference herein in its entirety.

### BACKGROUND

### 1. Technical Field

The present disclosure relates to an electrode body for a secondary battery.

### 2. Description of Related Art

There is a method of shortening a drying time by high-temperature drying in a drying step after coating a mixture slurry on a current collector layer, in order to increase the production efficiency of an electrode body for a secondary battery. When a binder contained in the mixture slurry is subjected to high-temperature drying, however, so-called binder migration in which the binder migrates from the adhesive surface to the surface occurs. When the binder migration occurs, a current collector and an active material layer are easily peeled off, which causes a decrease in battery performance.

Various disclosures have been made to suppress binder migration. Japanese Unexamined Patent Application Publication No. 2015-146272 (JP 2015-146272 A) discloses a method of manufacturing a negative electrode for a non-aqueous electrolyte secondary battery. In this manufacturing method, a slurry for forming a lower layer and a slurry for forming an upper layer are prepared. The slurry for forming a lower layer is prepared by kneading a high BET negative electrode active material having a specific surface area S1 based on BET method of 3 to 20 m² per gram and a binder in a solvent. The slurry for forming an upper layer is prepared by kneading a low BET negative electrode active material having a specific surface area S2 based on BET method of 2 to 6 m² per gram and a binder in a solvent. Here, S1 and S2 are determined such that the ratio (S2/S1) of S2 to S1 satisfies 0.1 to 0.9. The slurry for forming a lower layer is coated on a negative electrode current collector, the slurry for forming an upper layer is coated on the slurry for forming a lower layer, and the slurry for forming a lower layer and the slurry for forming an upper layer are simultaneously dried at 100 to 150° C., whereby a negative electrode active material layer including a lower layer and an upper layer is formed. Here, the slurry for forming a lower layer and the slurry for forming an upper layer are coated such that the ratio (T2/TA) of a thickness T2 of the lower layer to a total thickness TA of the negative electrode active material layer is 0.02 to 0.3. According to the present disclosure, it is possible to provide a negative electrode in which the negative electrode active material layer does not easily peel or collapse, even when drying is performed at a high temperature of 100° C. or higher.

Meanwhile, Japanese Unexamined Patent Application Publication No. 2015-015156 (JP 2015-015156 A) discloses a method of manufacturing an electrode body having an active material layer formed of two types of layers having different compositions of a binder. JP 2015-015156 A discloses a method of manufacturing a battery, including a first layer forming step and a second layer forming step of forming a second layer on the first layer. In the first layer forming step, a first layer is formed on the surface of a current collector using a first paste containing a first positive electrode active material, a hydrophilic binder, and a first solvent. In the second layer forming step, a second layer is formed using a second paste containing a second positive electrode active material, a hydrophobic binder, and a second solvent. The first solvent and the second solvent are selected such that the affinity of the first solvent for water is greater than the affinity of the second solvent for water. According to the present disclosure, it is possible to enhance durability by sufficiently bringing the lower layer into close contact with the surface of the current collector, and to suppress the flow of a current between the lower layer and the upper layer in the case of an overcharge state, thereby establishing a technique of manufacturing a highly safe battery.

### SUMMARY

In order to solve the problem that the current collector and the active material layer are easily peeled off by the binder migration, there is generally known an active material layer having a two-layer structure in which the amount of the binder in the lower layer is increased and the amount of the binder in the upper layer is reduced in order to suppress an increase in the ion resistance due to the increase in the amount of the binder. In this case, however, there is an issue that flexibility is low since the amount of the binder in the upper layer is small.

Thus, an object of the present disclosure is to provide a novel electrode body for a secondary battery capable of suppressing a decrease in binding strength between an active material layer and a current collector, securing flexibility, and suppressing an increase in ion resistance of the active material layer.

The present disclosure achieves the above object by the following measures.

### First Aspect

An electrode body comprising a current collector layer and an active material layer stacked on the current collector layer, in which: the active material layer includes a first layer on the current collector layer and a second layer on the first layer; a first binder contained in the first layer is composed of particles having a surface contact shape; and a second binder contained in the second layer is composed of particles having a point contact shape.

### Second Aspect

The electrode body according to the first aspect, in which a peel strength between the current collector layer and the first layer is 0.06 N/cm or more.

### Third Aspect

The electrode body according to the first or second aspect, in which the second layer has a bending degree of 0.083 or less.

### Fourth Aspect

A secondary battery including the electrode body according to any one of the first to third aspects.

### Fifth Aspect

A method of manufacturing an electrode body including a current collector layer and an active material layer stacked on the current collector layer, the method including: stacking a first layer on the current collector layer; and stacking a second layer on the first layer, in which: a first binder contained in the first layer is composed of particles having a surface contact shape; and a second binder contained in the second layer is composed of particles having a point contact shape.

According to the electrode body of the present disclosure, it is possible to provide a novel electrode body for a secondary battery capable of suppressing a decrease in binding strength between an active material layer and a current collector, securing flexibility, and suppressing an increase in ion resistance of the active material layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side cross-sectional view of one embodiment of an electrode body of the present disclosure;

FIG. 2A is a schematic view showing a state in which an active material layer having a binder and a current collector layer are bound to each other.

FIG. 2B is a schematic view illustrating a state in which an active material layer having a binder and a current collector layer are bound to each other.

### DETAILED DESCRIPTION OF EMBODIMENTS

### <Electrode Body>

The electrode body of the present disclosure includes:

The electrode body includes a current collector layer and an active material layer laminated on the current collector layer.

The active material layer includes a first layer on the current collector layer and a second layer on the first layer.

The first binder included in the first layer is composed of particles having a surface contact shape.

The second binder included in the second layer is composed of particles having a point contact shape.

The active material layer containing a binder (first binder) composed of particles having a surface-contact shape has excellent binding strength with respect to the current collector layer. Without wishing to be bound by theory, it is believed that this is because the first binder is composed of particles having a surface contact shape, the contact area with the current collector layer is large, and binder migration hardly occurs when the mixture slurry is dried at a high temperature.

An active material layer including a binder (second binder) composed of particles in a point contact shape can have a relatively small ion resistance while maintaining flexibility. Without wishing to be bound by theory, this is considered to be because the second binder is composed of particles having a point-contact shape, and therefore, even when the active material layer containing the second binder contains a sufficient amount of the binder to maintain flexibility, the ion conduction path is hardly obstructed by the binder.

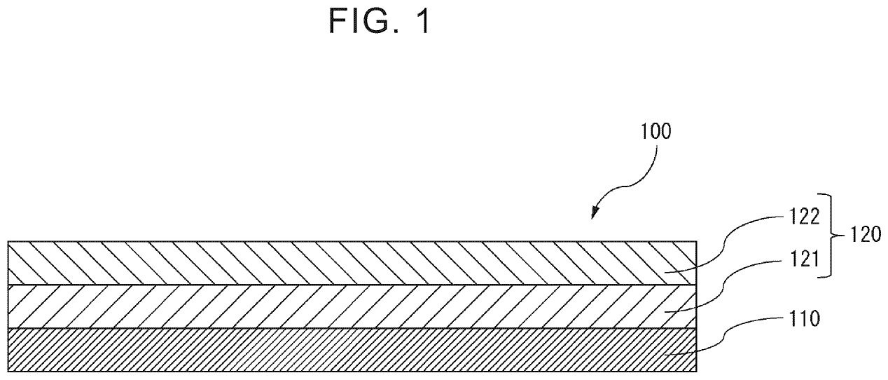

Specifically, for example, as shown in FIG. 1, the electrode body 100 of the present disclosure includes a current collector layer 110 and an active material layer 120. The active material layer 120 includes a first layer 121 and a second layer 122.

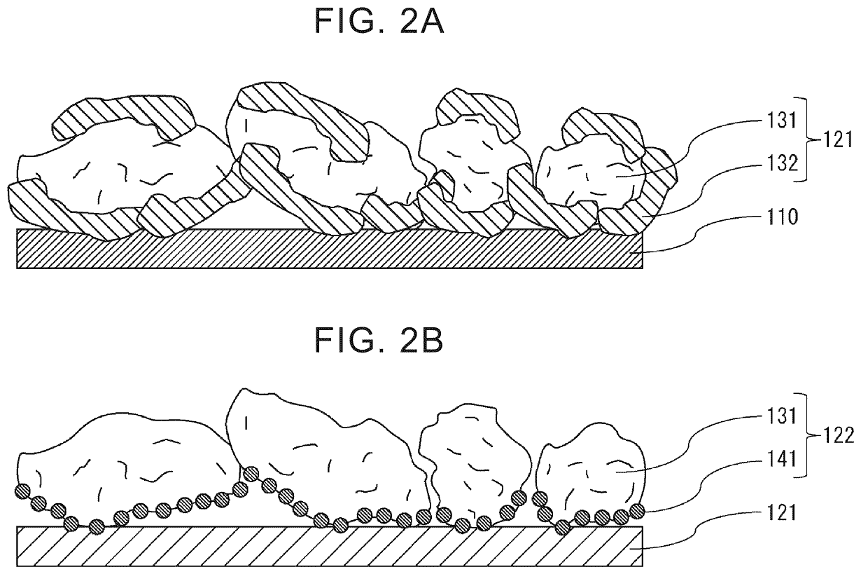

In FIG. 2A shown in the drawing, the first layer 121 including the first binder 132 and the active material 131 is bound to the current collector layer 110. Since the first binder 132 is composed of particles having a surface contact shape, the contact area between the first binder 132 and the current collector layer 110 is large, and binder migration hardly occurs when the mixture slurry is dried at a high temperature. Accordingly, the first layer 121 may have a strong binding force with respect to the current collector layer 110.

On the other hand, in FIG. 2B, the second layer 122 including the second binder 141 and the active material 131 is bonded to the first layer 121. In the second layer 122 including the second binder 141, even when a sufficient amount of the binder is contained in order to maintain flexibility, the second binder 141 is composed of particles having a point contact shape, so that the ion conduction path is hardly obstructed by the binder.

In the context of the present disclosure, “mixture” means a composition that can constitute an active material layer, either as it is or by containing other components. In addition, in the context of the present disclosure, a “mixture slurry” means a slurry that includes a dispersion medium in addition to a “mixture” and that can be coated and dried to form an active material layer.

Hereinafter, each component of the present disclosure will be described.

The electrode body of the present disclosure includes a current collector layer and an active material layer laminated on the current collector layer.

### <Active Material Layer>

The active material layer has a first layer on the current collector layer and a second layer on the first layer.

Peeling strength between the current collector layer and the first layer may be 0.06 N/cm or more, 0.07 N/cm or more, or 0.08 N/cm or more, 0.5 N/cm below, 0.4 N/cm below, 0.3 N/cm below, or 0.2 N/cm below.

The peel strength between the current collector layer and the first layer was calculated according to JIS-K-6854-1. Specifically, the material under test of the current collector layer on which the first layer was laminated was fixed to a hard base member with a double-sided tape or an adhesive, and thereafter, one end portion of the film was peeled off, and the end portion was fixed to a 90° peeling tester. The film was peeled while being pulled in a direction of 90° with respect to the non-peeled portion of the material to be tested, and the tensile strength was measured by a load cell or the like to calculate the film.

The flexion degree of the second layer may be not less than 0.083, not more than 0.080, not more than 0.070, or not more than 0.050, and may be not less than 0, not less than 0.010, or not more than 0.020.

The bending degree is an index indicating the conductivity of ions in the active material, and is calculated by the following calculation formula. The smaller the flexural value, the better the ion conductivity and the smaller the ion resistance.

$$τ = K ε / {{K}^{eff}}_{pos}$$

τ: Flexion degree (−)
K: Electrolyte conductivity (S/cm)
ε: Porosity (−)
K^{eff}ₚₒₛ: effective conductivity (S/cm)

The effective conductivity can be calculated by the following formula.

$${{K}^{eff}}_{pos} := L / ( SRion )$$

K^{eff}ₚₒₛ: effective conductivity (S/cm)
S: Electrode body area (cm²)
L: Electrode body thickness (cm)
Rion: Electrode body resistance (Q)

The porosity (ε) can be calculated by the following equation.

$$Porosity ( ε ) = 1 - [ apparent density of the second layer ( g / {cm}^{3} ) ] / [ true density of the second layer ( g / {cm}^{3} )$$

Here, the apparent density of the second layer can be calculated using the volume determined from the measured dimensions and the measured weight.

The electrode body resistance can be calculated by preparing two electrode bodies having the same configuration having only the second layer as the active material layer, fabricating symmetrical cells facing each other, and measuring the impedance of only the electrode bodies according to the AC impedance method.

The flexibility of the second layer is preferably such that cracks do not occur in the active material layer visually when the electrode body is wound around a diametrically 25.0 mm cylinder. The diameter of the cylinder may be 24.5 mm, 24.0 mm, 23.5 mm, or 23.0 mm or less.

The thickness of the active material layer is not particularly limited, and may be, for example, 100 μm or more, 200 μm, 300 μm or more, 350 μm or more, 370 μm or more, 390 μm or more, or 400 μm or more. The thickness of the active material layer may be, for example, 700 μm or less, 600 μm or less, 550 μm or less, 500 μm or less, 480 μm or less, 460 μm or less, or 450 μm or less.

The thickness of the first layer is preferably 0.4 times or more, 0.5 times or more, 0.6 times or more, 0.8 times or more, or 1.0 times or more of the thickness of the second layer from the viewpoint of the binding property to the current collector layer. It is preferable from the viewpoint of conductivity that the thickness of the first layer is 2.4 times or less, 2.3 times or less, 2.2 times or less, 2.0 times or less, or 1.8 times or less of the thickness of the second layer.

The active material layer may contain, in addition to the active material and the binder, a conductive auxiliary agent, a dispersant, various other additives, and the like.

### (Binder)

The first binder included in the first layer is composed of particles having a surface contact shape, and the second binder included in the second layer is composed of particles having a point contact shape.

The term “surface-contact-shaped particles” refers to particles having an average of 50% or more of a ratio (contact ratio) of a length in contact with other particles such as an active material, a current collector, and a binder with respect to an outer periphery of the particles when the particles are observed in a plane.

For example, a styrene-butadiene copolymer (SBR), polyacrylic acid (PAA), or the like can be used as the surface-contact-shaped grains.

The term “point-contact-shaped particles” refers to particles having an average length (contact ratio) of less than 50% in contact with other particles, such as an active material, a current collector, and a binder, with respect to the outer circumference of the particles when the particles are observed in a plane.

For example, a styrene-acrylic acid ester copolymer (SAR), polyvinylidene fluoride (PVDF), or the like can be used as the point-contact-shaped grains.

The particle diameter of the point contact-shaped particles is not particularly limited, and may be, for example, 0.05 μm or more, 0.1 μm or more, 0.2 μm or more, 0.5 μm or more, or 1.0 μm or more. The particle size of the point contact shape may be less than 5.0 micrometers, less than 4.0 micrometers, less than 3.0 micrometers, or less than 2.0 micrometers.

Herein, the term “particle size” means the mean of the projected area circle equivalent diameter determined from a scanning electron microscope (SEM) image or a transmission electron microscope (TEM) image.

The mass of the binder is not particularly limited, and may be, for example, 0.1 parts by mass or more, 0.2 parts by mass or more, 0.5 parts by mass or more, 1.0 parts by mass or more, or 2.0 parts by mass or more with respect to 100 parts by mass of the first layer or the second layer. The mass of the binder may be 5.0 parts by mass or less, 4.5 parts by mass or less, 4.0 parts by mass or less, 3.5 parts by mass or less, or 3.0 parts by mass or less.

### (Active Material)

The active material may be a positive electrode active material or a negative electrode active material.

The mass of the active material is not particularly limited, and may be, for example, 60 parts by mass or more, 70 parts by mass or more, 80 parts by mass or more, 90 parts by mass or more, 91 parts by mass or more, 92 parts by mass or more, 93 parts by mass or more, or 94 parts by mass or more with respect to 100 parts by mass of the first layer or the second layer. The mass of the active material may be less than 100 parts by mass, 99 parts by mass, 98 parts by mass or less, 97 parts by mass, or 96 parts by mass or less.

The material of the positive electrode active material is not particularly limited, and may be, for example, lithium cobaltate (LiCoO₂), lithium nickelate (LiNiO₂), lithium manganate (LiMn₂O₄), lithium nickel manganese cobalt oxide (NCM: LiCO_{1/3}Ni_{1/3}Mn_{1/3}O₂), lithium nickel cobalt aluminum oxide (LiNi_{0.8}(CoAl)_{0.2}O₂), a heterogeneous element-substituted Li—Mn spinel of a composition represented by Li₁₊ₓMn_{2-x-y}M_{y}O₄ (M is one or more metallic elements selected from Al, Mg, Co, Fe, Ni, and Zn), and the like.

The positive electrode active material is not particularly limited, and may have a coating layer. The coating layer is a layer containing a material having conductivity, low reactivity with a positive electrode active material or a solid electrolyte, and capable of maintaining a form of a coating layer that does not flow even when in contact with an active material or a solid electrolyte. In addition to LiNbO₃, Li₄Ti₅O₁₂, Li₃PO₄ may be exemplified, but is not limited thereto.

The shape of the positive electrode active material is not particularly limited as long as it has a general shape as the positive electrode active material of the battery. The positive electrode active material may be in a particulate form, for example. The particle diameter is not particularly limited, and may be 5 μm or more, 6 μm or more, 8 μm or more, 10 μm or more, or 12 μm or more, and may be 30 μm or less, 25 μm or less, 20 μm or less, or 15 μm or less.

The material of the negative electrode active material is not particularly limited, and may be metallic lithium or a material capable of occluding and releasing metallic ions such as lithium ions. Examples of the material capable of occluding and releasing metal ions such as lithium ions include, but are not limited to, alloy-based negative electrode active materials, carbon materials, and lithium titanate (Li₄Ti₅O₁₂).

The alloy-based negative electrode active material is not particularly limited, and examples thereof include a Si alloy-based negative electrode active material, a Sn alloy-based negative electrode active material, and the like. The Si alloy-based negative electrode active material includes silicon, silicon oxides, silicon carbides, silicon nitrides, solid solutions thereof, and the like. The Si alloy-based negative electrode active material may also include metallic elements other than silicon, such as Fe, Co, Sb, Bi, Pb, Ni, Cu, Zn, Ge, In, Sn, and Ti, for example. The Sn alloy-based negative electrode active material includes tin, tin oxides, tin nitrides, solid solutions thereof, and the like. The Sn alloy-based negative electrode active material may also include metallic elements other than tin, such as Fe, Co, Sb, Bi, Pb, Ni, Cu, Zn, Ge, In, Ti, and Si, for example.

The carbon material is not particularly limited, and examples thereof include hard carbon, soft carbon, and graphite.

The shape of the negative electrode active material is not particularly limited, and may be any general shape as the negative electrode active material of the battery. The negative electrode active material may be in particulate form, for example. The particle diameter is not particularly limited, and may be 5 μm or more, 6 μm or more, 8 μm or more, 10 μm or more, or 12 μm or more, and may be 30 μm or less, 25 μm or less, 20 μm or less, or 15 μm or less.

### (Dispersants)

The dispersant is not particularly limited, and may be, for example, carboxymethylcellulose (CMC), polyvinyl alcohol (PVA), polyvinyl butyral (PVB), polyvinyl pyrrolidone (PVP), polyacrylates, polymethacrylates, polyoxyethylene alkyl ethers, polyalkylene polyamines, benzimidazoles, and the like.

The mass of the dispersant may be, for example, 0.1 or more parts by mass, 0.3 or more, 0.5 or more parts by mass, 1.0 or more, or 2.0 or more parts by mass with respect to 100 parts of the first layer or second layer, not less than limited. The mass of the dispersant may be 5.0 parts by mass or less, 4.5 parts by mass or less, 4.0 parts by mass or less, 3.5 parts by mass or less, or 3.0 parts by mass or less.

### (Conductive Assistant)

The conductive aid is not particularly limited. The conductive aid may be, for example, but not limited to, vapor-grown carbon fiber (VGCF), acetylene black (AB), Ketjen black (KB), carbon nanotube (CNT), carbon nanofiber (CNF), and the like. The conductive auxiliary agent may be, for example, particulate or fibrous, and the size thereof is not particularly limited. The conductive auxiliary agent is not particularly limited, and only one kind may be used alone, or two or more kinds may be used in combination.

The mass of the conductive auxiliary agent is not particularly limited, and may be, for example, 0.005 parts by mass or more, 0.01 parts by mass or more, 0.02 parts by mass or more, 0.03 parts by mass or more, or 0.05 parts by mass or more with respect to 100 parts by mass of the first layer or the second layer. The mass of the conductive auxiliary agent may be 0.10 parts by mass or less, 0.09 parts by mass or less, 0.08 parts by mass or less, 0.07 parts by mass or less, or 0.06 parts by mass or less.

### <Current Collector Layer>

The material of the current collector layer that can be used for the positive electrode is not particularly limited, and a general material as a positive electrode current collector of a battery can be appropriately adopted. Examples of materials used for the positive electrode current collector layers include, but are not limited to, Cu, Ni, Cr, Au, Pt, Ag, Al, Fe, Ti, Zn, Co, and stainless-steel. Further, the positive electrode current collector layer may have some coating layer on the surface thereof for the purpose of adjusting the resistance or the like. The positive electrode current collector layer may be formed by plating or depositing the metal on a metal foil or a base material.

The shape of the positive electrode current collector layer is not particularly limited, and may be, for example, a foil shape, a plate shape, or a mesh shape.

The thickness of the positive electrode current collector layers is not particularly limited, and may be 0.1 μm or more, or 1 μm or more, and may be 1 mm or less, or 100 μm or less.

The material of the current collector layer that can be used for the negative electrode is not particularly limited, and a general material as a negative electrode current collector of a battery can be appropriately adopted. Examples of the material used for the negative electrode current collector layer include, but are not limited to, Cu, Ni, Cr, Au, Pt, Ag, Al, Fe, Ti, Zn, Co, stainless-steel, and carbon sheet. The negative electrode current collector layer may have some coating layer on the surface thereof for the purpose of adjusting resistance or the like.

The shape of the negative electrode current collector layer is not particularly limited, and may be, for example, a foil shape, a plate shape, or a mesh shape.

The thickness of the negative electrode current collector layers is not particularly limited, and may be 0.1 μm or more, or 1 μm or more, and may be 1 mm or less, or 100 μm or less.

### <Secondary Battery>

A secondary battery of the present disclosure includes the electrode body. The electrode body may be a positive electrode or a negative electrode.

The electrolyte included in the secondary battery of the present disclosure may be a solid electrolyte or a liquid electrolyte held by a separator.

### Electrolytes

The material of the solid electrolyte is not particularly limited, and may be, for example, a sulfide solid electrolyte, an oxide solid electrolyte, or a polymer electrolyte.

Examples of sulfide solid electrolyte include, but are not limited to, a sulfide-based amorphous solid electrolyte, a sulfide-based crystalline solid electrolyte, an argyrodite-type solid electrolyte, and the like. Specific examples of the sulfide solid electrolyte include, but are not limited to, Li₂S—P₂S₅-based materials (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂(Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; and combinations thereof.

Examples of the oxide solid electrolyte include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄ₓNₓ(LiPON), etc.; and combinations thereof.

The sulfide solid electrolyte and the oxide solid electrolyte may be glass or crystallized glass (glass ceramics).

Examples of polymer electrolytes include polyethylene oxide (PEO), polypropylene oxide (PPO), copolymers thereof and the like, but are not limited to these.

The liquid electrolyte is not particularly limited, and preferably contains a supporting salt and a solvent.

The support salt (lithium salt) of the liquid electrolyte having lithium ion conductivity is not particularly limited, and examples thereof include an inorganic lithium salt and an organic lithium salt. Examples of the inorganic lithium salt include, but are not limited to, LiPF₆, LiBF₄, LiClO₄, LiAsF₆, etc. Examples of the organic lithium salt include, but are not limited to, LiCF₃SO₃, LiN(CF₃SO₂)₂, LiN(C₂F₅SO₂)₂, LiN(FSO₂)₂, LiC(CF₃SO₂)₃, etc.

The solvent used in the liquid electrolyte is not particularly limited, and examples thereof include cyclic carbonate and chain carbonate. Examples of the cyclic carbonate include, but are not limited to, ethylene carbonate (EC), propylene carbonate (PC), and butylene carbonate (BC). Examples of the linear carbonate include, but are not limited to, dimethyl carbonate (DMC), diethyl carbonate (DEC), ethyl methyl carbonate (EMC), and the like. The liquid electrolyte is not particularly limited, and only one type may be used alone, or two or more types may be used in combination.

The separator is not particularly limited, and a general separator of a battery may be appropriately employed. Examples of the separator include polyolefin-based, polyamide-based, and polyimide-based nonwoven fabrics.

### <Method for Manufacturing Electrode Body>

A method of manufacturing an electrode body of the present disclosure is a method of manufacturing an electrode body including a current collector and an active material layer laminated on the current collector layer.

The method includes laminating a first layer on a current collector and laminating a second layer on the first layer.

The first binder included in the first layer is composed of particles having a surface contact shape.

The second binder included in the second layer is composed of particles having a point contact shape.

According to the method for manufacturing an electrode body of the present disclosure, it is possible to provide a novel electrode body for a secondary battery capable of suppressing a decrease in binding strength between an active material layer and a current collector, securing flexibility, and suppressing an increase in ion resistance of the active material layer even when the mixture slurry is dried at a high temperature.

Hereinafter, each component of the present disclosure will be described.

### <Lamination of First Layer>

A method of manufacturing an electrode body of the present disclosure includes laminating a first layer on a current collector. In addition, the first binder included in the first layer is composed of particles having a surface contact shape. For the current collector, the first layer, and the first binder, reference can be made to the description of the electrode body described above.

The lamination of the first layer may include coating and drying the first mixture slurry. The first mixture slurry means a slurry including an active material and a first binder. For the active material, reference can be made to the description of the electrode body described above.

The viscosity of the first mixture slurry is not particularly limited, and may be, for example, greater than or equal to 90 Pa·s, greater than or equal to 100 Pa·s, greater than or equal to 150 Pa·s, or greater than or equal to 200 Pa at a shear rate 0.1 s⁻¹. The first mixture may be less than or equal to 500 Pa·s, less than or equal to 400 Pa·s, less than or equal to 300 Pa·s, or less than or equal to 250 Pa·s.

The coating step is a step of coating the first mixture slurry on the current collector layer.

The application method is not particularly limited, and may include, for example, a doctor blade method, a die coat method, a gravure coat method, a spray application method, an electrostatic application method, a bar application method, and the like.

The drying step is a step of drying the coated first mixture slurry.

The drying method is not particularly limited, and may be, for example, hot air drying, hot air drying, infrared drying, vacuum drying, dielectric heating drying, or the like.

The drying temperature is not particularly limited, and may be 50° C. or higher, 70° C. or higher, 90° C. or higher, 100° C. or higher, 110° C. or higher, or 120° C. or higher, and may be 200° C. or lower, 180° C. or lower, 160° C. or lower, 150° C. or lower, or 140° C. or lower.

### <Lamination of Second Layer>

A method of manufacturing an electrode body of the present disclosure includes laminating a second layer on the first layer. In addition, the second binder included in the second layer is composed of particles having a point contact shape. For the second layer and the second binder, reference can be made to the description of the electrode body described above.

The lamination of the second layer may include coating and drying the second mixture slurry. The second mixture slurry means a slurry including an active material and a second binder. For the active material, reference can be made to the description of the electrode body described above.

The viscosity of the second mixture slurry is not particularly limited, and may be, for example, greater than or equal to 90 Pa·s, greater than or equal to 100 Pa·s, greater than or equal to 150 Pa·s, or greater than or equal to 200 Pa at a shear rate 0.1 s⁻¹. The second mixture may be less than or equal to 500 Pa·s, less than or equal to 400 Pas, less than or equal to 300 Pa·s, or less than or equal to 250 Pa·s.

The coating step is a step of coating the second mixture slurry on the first layer. For the coating method, reference can be made to the above description regarding the lamination of the first layer.

The drying step is a step of drying the second mixture slurry to form a second layer. The drying step may be performed on the respective layers after the first mixture slurry coating and after the second mixture slurry coating, or may be performed collectively on both layers. For the coating method, reference may be made to the above description of the lamination of the first layer.

### Example 1

The present disclosure will be described in detail with reference to Examples and Comparative Examples, but the present disclosure is not limited thereto.

### <Preparation of Electrode Body>

### Example 1

Lithium cobaltate (LiCoO₂) as an active material, styrene-butadiene copolymer (SBR) as a binder forming surface-contact-shaped particles, carbon nanotubes (CNT) as a conductive aid, and carboxymethylcellulose (CMC) as a dispersant were weighed at a weight ratio of 95:3.9:0.1:1 in seconds. They were mixed with ion-exchanged water and the mixture was adjusted to viscous 120 Pa·s (shear rate 0.1 s⁻¹) to produce a first mixture slurry.

Lithium cobaltate (LiCoO₂) as an active material, a styrene-acrylic acid ester copolymer (SAR) as a binder forming point-contact-shaped particles, carbon nanotubes (CNT) as a conductive aid, and carboxymethylcellulose (CMC) as a dispersant were weighed at a weight ratio of 95:3.9:0.1:1 in seconds. They were mixed with ion-exchanged water and the mixture was adjusted to viscous 120 Pa·s (shear rate 0.1 s⁻¹) to produce a second mixture slurry.

The first mixture slurry was applied to the surface of the copper foil as a current collector layer at a thickness of 210 μm and dried at 100° C. for 3 minutes. Further, the surface of the first mixture slurry, the second mixture slurry was applied at a thickness of 210 μm, and dried for 3 minutes at 100° C., to prepare an electrode body of Example 1.

### Comparative Example 1

An electrode body as Comparative Example 1 was prepared in the same manner as in Example 1, except that the second layer in Example 1 was not coated and the thickness of the first layer was applied at 420 μm.

### Comparative Example 2

An electrode body as Comparative Example 2 was prepared in the same manner as in Example 1, except that the first layer in Example 1 was not applied and the thickness of the second layer was applied at 420 μm.

### <Evaluation>

### <Evaluation of Binding Strength Between Active Material Layer and Current Collector Layer>

In Examples and Comparative Examples 1 and 2, the peel strength of the active material layer and the current collector layer was measured by a 90° peel tester, and the binding strength was evaluated. Evaluation criteria were as follows.
A: The peel strength is 0.06 N/cm or higher.
B: The peel strength is less than 0.06 N/cm.

### <Evaluation of Flexibility of Electrode Body>

In Examples and Comparative Examples 1 and 2, the electrodes were wound around a cylinder having a diametric 25 mm. Then, the flexibility was evaluated by whether or not the crack of the active material layer was visually confirmed. Evaluation criteria were as follows.
A: Cracks were observed in the active material layer.
B: No cracks were found in the active material layer.

### <Evaluation of Flexibility of Active Material Layer>

In Examples and Comparative Examples 1 and 2, the ion resistance of the active material layer was evaluated by measuring the degree of bending of the active material layer. Evaluation criteria were as follows.
A: The degree of flexion is 0.083 or less.
B: The degree of flexion exceeds 0.083.

Evaluation results are given in Table 1.

TABLE 1

| | | | Comparative | Comparative |
|---|---|---|---|---|
| | Example 1 | | Example 1 | Example 2 |
| Binder | Layer 1 | SBR | SBR | SAR |
| | Second layer | SAR | | |

| Binding strength | Peel strength (N/cm) | 0.07 | 0.08 | 005 |
|---|---|---|---|---|
| | Evaluation | A | A | B |
| Flexibility | Evaluation | A | A | A |
| Bending degree | Bending degree | 0.078 | 0.090 | 0.079 |
| | Evaluation | A | B | A |

From Example 1 and Comparative Example 2 in Table 1, it can be understood that the first layer having a binder composed of particles having a surface-contact shape faces the current collector layer, and thus has a high binding strength.

From Example 1 and Comparative Example 1 in Table 1, it can be understood that the inclusion of the second layer having the binder composed of the particles having the point contact shape suppresses the increase in the degree of flexure while maintaining the flexibility.

What is claimed is:

1. An electrode body comprising a current collector layer and an active material layer stacked on the current collector layer, wherein:
the active material layer includes a first layer on the current collector layer and a second layer on the first layer;
a first binder contained in the first layer is composed of particles having a surface contact shape; and
a second binder contained in the second layer is composed of particles having a point contact shape.

2. The electrode body according to claim 1, wherein a peel strength between the current collector layer and the first layer is 0.06 N/cm or more.

3. The electrode body according to claim 1, wherein the second layer has a bending degree of 0.083 or less.

4. A secondary battery comprising the electrode body according to claim 1.

5. A method of manufacturing an electrode body including a current collector layer and an active material layer stacked on the current collector layer, the method comprising:
stacking a first layer on the current collector layer; and
stacking a second layer on the first layer, wherein:
a first binder contained in the first layer is composed of particles having a surface contact shape; and
a second binder contained in the second layer is composed of particles having a point contact shape.
